(19) United States
(12) Patent Application Publication
(10) Pub. No.: US 2010/0109840 A1
(43) Pub. Date: May 6, 2010

(54) Radio Frequency Identification Read Antenna

(76) Inventor: Robert Schilling, Londonderry, NH (US)

Correspondence Address: Jaekle Fleischmann & Mugel, LLP, 12 Fountain Plaza, Buffalo, NY, 14202-2292, US

(21) Appl. No.: 12/262,740

(22) Filed: Oct. 31, 2008

(51) Int. Cl. G06K 7/00; H01Q 1/50; H01Q 13/10

(52) U.S. Cl. 340/10.1; 343/850; 343/770

(57) ABSTRACT

A radio frequency identification (RFID) read antenna is provided. The RFID antenna includes an aperture board having at least one opening and a dielectric patch element spaced a distance from the aperture. The RFID antenna further includes a quadrature coupler connected to the aperture board and configured to excite the dielectric patch element to generate RFID signals.

### BACKGROUND OF THE INVENTION

This invention relates generally to radio frequency identification (RFID) systems, and more particularly to an antenna for RFID systems.

RFID systems are increasingly used to acquire information that may be used, for example, to monitor and track products and processes. For example, RFID systems may be used to monitor the inventory of products in a retail environment. RFID systems provide automatic identification capabilities using the storage and remote retrieval of data from RFID tags or transponders. An RFID tag can be attached to or integrated within a product or product packaging. These RFID tags receive and respond to radio frequency (RF) signals to provide information, for example, related to the product to which the RFID tag is attached. For example, modulators of the RFID tags may transmit back a signal using a transmitter or reflect back a signal to RFID readers. Additionally, information may be communicated to the RFID tags (e.g., encoding information) using RFID encoders.

RFID systems include RFID readers that can detect and receive information from a large number of RFID tags at the same time. These RFID readers may be fixed/stationary and/or portable (e.g., handheld RFID reader). For example, fixed RFID readers may be positioned at dock doors to read the RFID tags of products on pallets or cases that pass by the RFID readers. RFID readers also may be handheld and used, for example, by individuals walking through a retail store or business reading RFID tags of products on shelves or in a storage area. However, RFID readers may be used in many different applications other than product identification and tracking, including, for example, animal identification, file folder identification in an office, airline baggage tracking, building access control, electronic traffic toll collection, among many others.

The required UHF RFID communication range encompasses different frequencies throughout the world. In particular, in European Union (EU) countries, the UHF RFID frequency band is designated from 865 MHz to 868 MHz (0.3% bandwidth). In the United States (U.S.), the UHF RFID frequency band is designated from 902 MHz to 928 MHz (2.8% bandwidth). In Asian countries, the UHF RFID frequency band is designated from 950 MHz to 956 MHz (0.6% bandwidth). Different read antennas configured to operate in each of these frequency ranges are separately provided, for example, in connection with REID readers for use in different countries. Currently, separate antennas configured to operate in each of these designated frequency ranges are needed because the RFID tags are of an arbitrary linear polarization and it is desirable for the interrogator antenna in the RFID reader to be circularly polarized with very good axial ratio, typically 2 dB or less. Antennas designed to support this axial ratio requirement require different configured RFID reader devices to provide the necessary phase and amplitude split.

Thus, although there may be lower cost versions of an RFID reader with an antenna configured for use in the U.S. that is in compliance with the designated U.S. UHF RFID frequency range, the RFID reader fails to comply with the operating requirements in the EU and Asia. In particular, the RFID reader with antenna for use in the U.S. is not capable of supporting operation in an RFID system in the EU or Asia, and in particular, to complying with the different frequency and axial ratio requirements.

### BRIEF DESCRIPTION OF THE INVENTION

In accordance with one embodiment, a radio frequency identification (RFID) antenna is provided that includes an aperture board having at least one opening and a dielectric patch element spaced a distance from the aperture. The RFID antenna further includes a quadrature coupler connected to the aperture board and configured to excite the dielectric patch element to generate RFID signals.

In accordance with another embodiment, a radio frequency (RFID) reader is provided. The RFID reader includes a transceiver configured to generate RFID signals over a UHF RFID frequency range from about 865 MHz to about 956 MHz, with the generated RFID signals having an axial ratio of no more than about two decibels. The RFID reader further includes an antenna connected to the transceiver and having an aperture coupled patch element.

In accordance with yet another embodiment, a method of transmitting RFID signals is provided. The method includes generating an RFID signal in a frequency range of about 865 MHz to about 956 MHz and transmitting the RFID signal using an aperture coupled patch element.

### BRIEF DESCRIPTION OF THE DRAWINGS

FIG. 1 is a block diagram of one configuration of a radio frequency identification (RFID) system in which an RFID antenna constructed in accordance with various embodiments of the invention may operate.

FIG. 2 is a block diagram of another configuration of a radio frequency identification (RFID) system in which an RFID antenna constructed in accordance with various embodiments of the invention may operate.

FIG. 3 is a block diagram of another configuration of a radio frequency identification (RFID) system in which an RFID antenna constructed in accordance with various embodiments of the invention may operate.

FIG. 4 is a block diagram of an RFID tag that may be read using an REID antenna constructed in accordance with various embodiments of the invention.

FIG. 5 is a block diagram of another RFID tag that may be read using an RFID antenna constructed in accordance with various embodiments of the invention.

FIG. 6 is a block diagram of an RFID reader constructed in accordance with various embodiments of the invention.

FIG. 7 is a block diagram of an RFID antenna constructed in accordance with various embodiments of the invention.

FIG. 8 is cross-sectional view of an RFID antenna constructed in accordance with various embodiments of the invention.

FIG. 9 is a top plan view of an aperture board constructed in accordance with various embodiments of the invention.

FIG. 10 is a bottom view of a base having a quadrature coupler constructed in accordance with various embodiments of the invention.

FIG. 11 is a top view of a radome constructed in accordance with various embodiments of the invention.

FIG. 12 is a top view of another radome constructed in accordance with various embodiments of the invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose processor or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments of the invention provide an antenna for a radio frequency identification (RFID) reader. The antenna is configured to allow operation in any of the European Union (EU) UHF RFID frequency band from 865 MHz to 868 MHz (0.3% bandwidth), the United States (U.S.) UHF RFID frequency band from 902 MHz to 928 MHz (2.8% bandwidth) and the Asian UHF RFID frequency band from 950 MHz to 956 MHz (0.6% bandwidth), while providing the desired or needed axial ratio, which in at least one embodiment is 2 dB or less (i.e., no more than about 2 dB).

It should be noted that although the various embodiments of an RFID antenna and reader may be described in connection with a particular application or for sensing a particular event, for example, tracking products, the various embodiments are not limited to a particular application or to sensing a particular event. The various embodiments may be implemented in any application or system wherein RFID information is read.

FIGS. 1 through 3 illustrate configurations of an RFID system 50 in which an RFID reader having an RFID antenna constructed according to various embodiments of the invention may be implemented. The RFID system 50 generally includes an REID communication device, such as an RFID reader 52 and a plurality of identification devices (not shown), for example, a plurality of RFID tags associated with different objects 54 (e.g., connected to different objects 54). The REID reader 52 and RFID tags communicate via radio frequency (RE) and generally operate in accordance with known RFID communication methods. For example, as shown in FIG. 1, the objects 54 may be supported on a support structure 56 with each object having attached thereto or integrated therewith one or more RFID tags as is known. For example, the objects 54 may be products, such as retail products and the support structure 56 a shelf for displaying the objects 54. It should be noted that the objects may be of different size and shape. Additionally, the objects may be constructed of different materials with the RFID tag located on the outside or within the product or product packaging as is known.

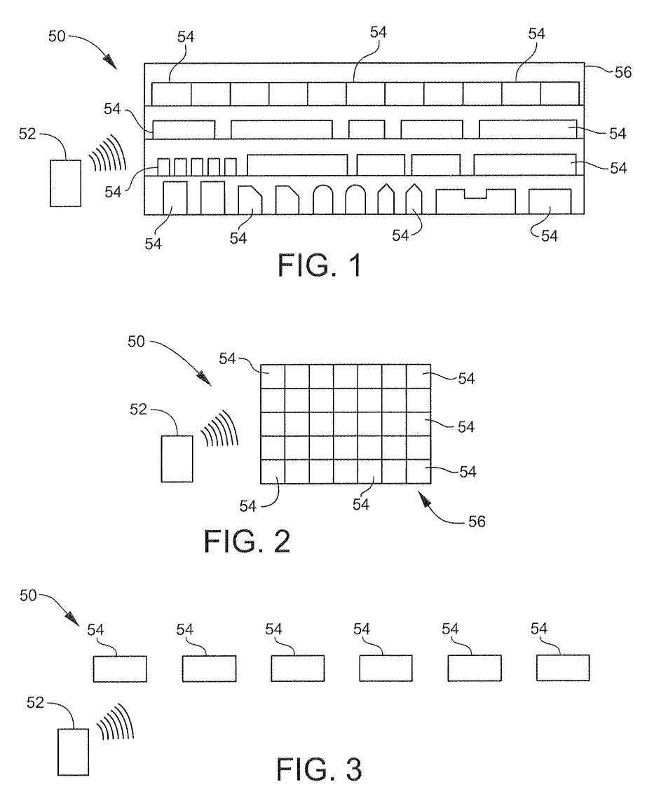

In another configuration, as shown in FIG. 2, a plurality of objects 54 may be located within a support structure 56. For example, the plurality of objects 54 may be boxes and the support structure 56 a crate/case or similar structure for transporting the structure. The RFID reader 52 may be used to communicate with RFID tags associated with the objects 54 while the support structure 56 is stationary or in motion. In still another configuration, as shown in FIG. 3, the objects 54 may not be supported by a support structure and the objects 54 may be stationary or in motion. For example, the objects 54 may be luggage or vehicles having RFID tags attached therewith.

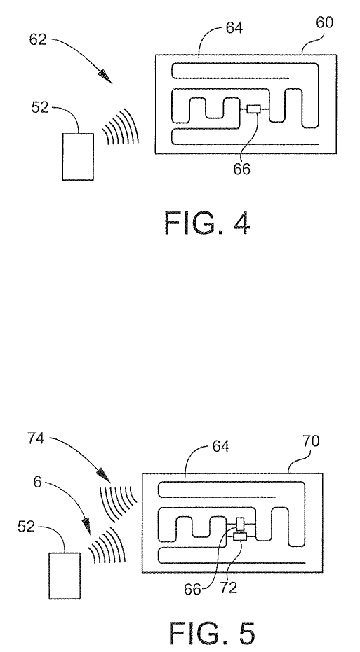

In various embodiments, the RFID tags 60 are passive radio reflective identification tags or passive RFID tags as shown in FIG. 4. The passive RFID tags 60 do not include a battery or other power source and when radio waves 62 from the RFID reader 52 or other RFID interrogator (as is known) are detected by an antenna 64 of the RFID tag 60, the energy is converted by the antenna 64 into electricity that can power up, for example, a processor, such as a microchip 66 in the RFID tag 60. The RFID tag 60 is then able to communicate, and more particularly, transmit to the RFID reader 52 information stored in the microchip 66. For example, the information transmitted may include the type of object to which the RFID tag 60 is connected, including, for example, a serial number, the time and date of the transmission, the location of the RFID tag 60 transmitting the information, etc. and which is generally referred to herein as RFID tag information.

In other various embodiments, RFID tags 70 are active radio identification tags or active RFID tags as shown in FIG. 5. The active RFID tags 70 also include a transmitter 72 to communicate, and more particularly, transmit (as opposed to reflecting back) signals 74 to the RFID reader 52 having the RFID tag information. The active RFID tags 70 use a battery (not shown) or other power source (e.g., optically powered) to transmit the signals 74 to the RFID reader 52.

It should be noted that the objects 54 shown in FIGS. 1 through 3, or other objects may include only active RFID tags, only passive RFID tags or a combination of active and passive RFID tags. A determination of which type of RFID tag to use may be based on the particular application, for example, the distance over which the RFID tags must be detected (e.g., long distance versus short distance). This may determined, for example, based on the type of products and location of the products having the RFID system implemented in connection therewith.

It should be noted that the RFID reader 52 may be a stand alone unit, for example, a portable or handheld unit or may be integrated with another communication device, such as mobile or cellular telephones, personal digital assistants (PDAs), Blackberry devices, etc. Alternatively, components within, for example, the cellular telephone, such as the transceiver, processor and/or software may be modified to provide the same functionality and operation of the RFID reader 52. Still other alternatives include a plug-in or add-on unit, such as, a plug-in module for a PDA that includes therein the RFID reader 52.

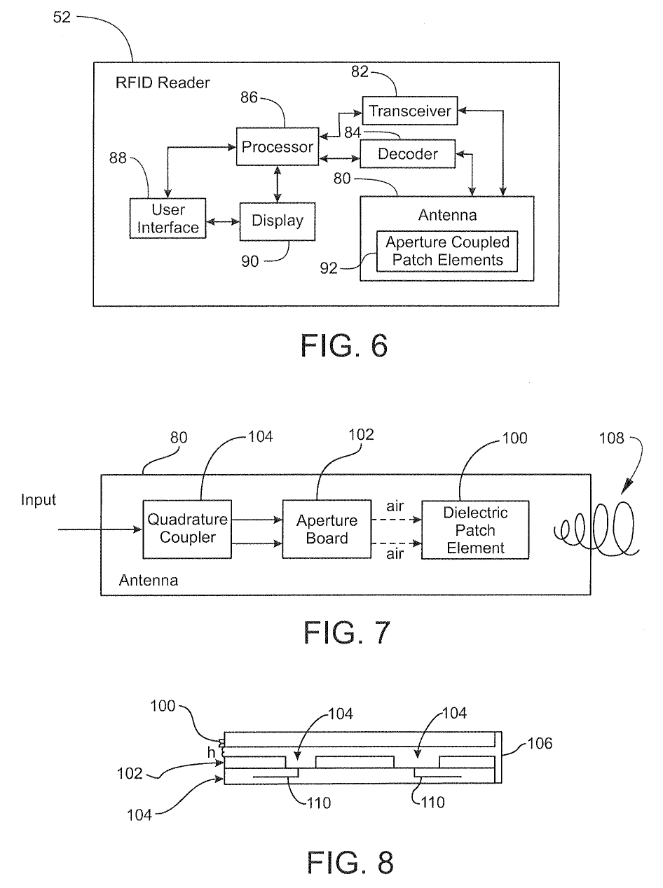

In various embodiments, as shown in FIG. 6, the RFID reader 52 includes an antenna 80 having an aperture coupled patch element 92 as described in more detail below. The antenna 80 is connected to a transceiver 82 and a decoder 84. It should be noted that the transceiver 82 and decoder 84 may be provided as a single unit. Additionally, in an alternate embodiment, the transceiver 82 is replaced by a separate transmitter (not shown) and receiver (not shown). In general, a transmitting portion and receiving portion are provided, for example, as a transceiver 82. Further, a processor 86 is connected to the transmitter 82 and the decoder 84. A user interface 88 also is connected to the processor 86 and to a display 90.

It should be noted that the antenna 80 may be provided as part of the RFID reader 52, for example, integrated therewith, such as in a single housing. Alternatively, the antenna 80 may be provided as a separate unit that may be connected to the RFID reader 52.

In operation, the antenna 80, which may be configured as a scanning antenna, transmits radio frequency (RF) signals, for example, RFID signals. The transceiver 82 may be configured such that the RF signals are transmitted over a determined range, for example, a short range (e.g., 5 feet or 10 feet). Also, the transceiver 82 may be configured such that RF signals are transmitted from the antenna 80 using any one of the EU UHF RFID frequency band from 865 MHz to 868 MHz, the U.S. UHF RFID frequency band from 902 MHz to 928 MHz and the Asian UHF RFID frequency band from 950 MHz to 956 MHz.

The RF signals, which are essentially RF radiation, allow communication with the RFID tags 60 and 70 (shown in FIGS. 4 and 5) as is known. In particular, the RF signals allow communication with the microchip 66 (shown in FIGS. 4 and 5) of the RFID tags 60 and 70. The RF radiation provides energy to energize passive RFID tags, such as the RFID tag 60 to allow communication with the RFID tag 60. When the REID tag 60 or 70 passes through an RF radiation field generated by the RF reader 52 and transmitted by the antenna 80, the REID tag 60 or 70 detects the signal (e.g., activation signal) from the RFID reader 52. The RFID tag 60 or 70 is activated, which may include energizing the RFID tag 60 or 70 and RFID tag information that is stored therein, such as on the microchip 66, is transmitted back to the RFID reader 52. For example, the RFID tag information may be reflected back by the RFID tag 60 or may be transmitted back using the transmitter 72 (shown in FIG. 5) of the RFID tag 70.

Upon receiving the signals from the RFID tags 60 and 70 via the antenna 80 using the transceiver 82, and that includes the RFID tag information, the signals are decoded in any known manner, for example, using the decoder 84. It should be noted that RFID tag information from a plurality of RFID tags 60 and/or 70 may be transmitted at the same time. The RFID tag information then may be processed using the processor 86 and the results displayed on the display 90. For example, information relating to the quantity and type of products to which the RFID tags 60 or 70 are attached may be displayed on the display 90. Further, and for example, a user may select the type of information to be displayed or provide other inputs using the user interface 88 (e.g., a keyboard). It should be noted that in various embodiments the RFID reader 52 is a portable device, for example, a handheld device provided, for example, in a scanner type configuration. In another various embodiments, the RFID reader 52 is a fixed or stationary device and configured to be attached to a support structure, for example, a wall, door frame, etc.

In various embodiments, the antenna 80 is configured as shown in FIG. 7 having a dielectric patch element 100 that is air coupled to an aperture board 102 to define an aperture coupled patch antenna. The aperture coupled patch antenna is any arrangement wherein there is no electrical connection between the aperture board 102 and the dielectric patch element 100. The aperture board 102 is connected to a quadrature coupler 104 that receives an input signal, for example, from an input feed line from the transceiver 82 (shown in FIG. 6). In one embodiment, the quadrature coupler 104 is quadrature coupled power divider that provides and equal power split (−3 dB) and phase difference (90 degrees) over the entire 865 MHz to 956 MHz frequency band. For example, the quadrature coupler 104 may be a 0-90 degree hybrid coupler.

The aperture board 102 includes one or more openings 104 as shown in FIG. 8, which may be configured as slots. The openings 104 may extend entirely through the aperture board 102 or only through a portion thereof. The dielectric patch element 100 is spaced a distance h above the aperture board 102. For example, the dielectric element 100 may be spaced a predetermined or pre-set height above the aperture board 102 and held in place by a bracket 106 to define an air gap between the aperture board 102 and the dielectric element 100. The dielectric element 100 and aperture board 102 may alternatively be spaced apart within a housing (not shown) of the antenna 80. In some embodiments, and as described in more detail below, the dielectric element 100 is provided outside the housing of the antenna, for example, on the radome.

In operation, the aperture coupling to the dielectric patch element 100 through the air provides a significant increase in the bandwidth response of the dielectric patch element 100. In one embodiment, the openings 104 are two slots defining a dual aperture with the slots oriented at 90 degrees with respect to each other and fed by output ports 110 of the quadrature coupler 104 shown in FIG. 7. IN at least one embodiment, this arrangement excites the dielectric patch element 100 in a circular polarization 108 over the entire 865 MHz to 956 MHz frequency band with an axial ratio of 2 dB or less (i.e., no more than about 2 dB).

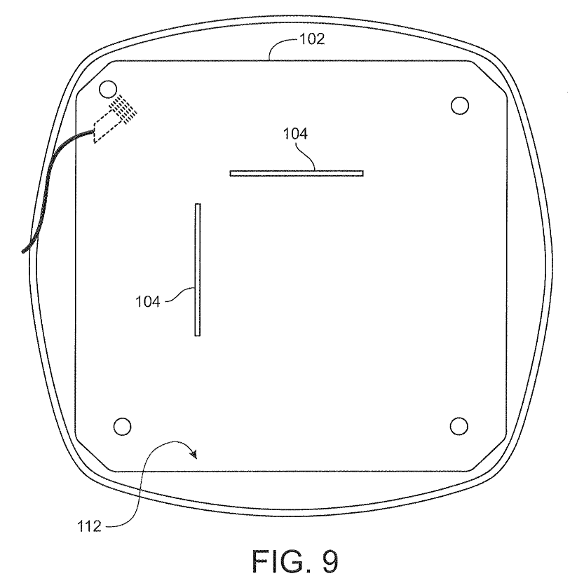

In one embodiment, the openings 104 are orthogonal slots that extend along a portion of a top surface 112 of the aperture board 102 as shown in FIG. 9. The openings 104 are offset from a center of the aperture board 102 and the ends of each opening 104 do not intersect the axis of the other opening 104. For example, the openings 104 may form two partial sides of a square or rectangular shaped configuration. The openings 104 may be of any shape or size and are not limited to slots. In one embodiment, the openings 104 are slots having a length of about 50 millimeters (mm) and a width of about 5 mm. Also, the openings 104 may be positioned at different regions of the aperture board 102 and at different orientations with respect to each other. Additional of fewer openings 104 may be provided. For example, a four slot array may be provided with a microstrip feed array outputting signals to each of the slots as generated by the quadrature coupler 104 (or other coupler device). The aperture board 102 may be formed of any material, for example, metal such as steel.

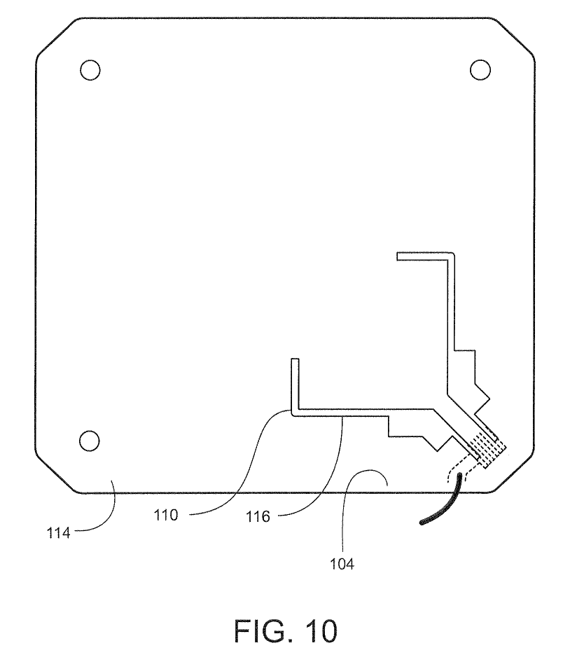

The aperture board 102 may be provided on a base 114 as shown in FIG. 10 with the quadrature coupler 104 provided on the opposite side of the base 114. For example, the aperture board 102 and quadrature coupler 104 may be adhered or affixed to opposite sides of the base 114 using any known adhesion or connection means. In this embodiment, the quadrature coupler 104 includes two output ports 110 that may be formed from two stripline elements 116, for example, two microstrips. Each of the stripline elements 116 extend along the base 114 such that a at least a portion of the stripline elements 116 extend across a corresponding opening 104 of the aperture board 102 on the opposite side the base 114. For example, an end of each of the stripline elements 116 may extend generally perpendicular to and across a middle portion of the openings 104 on the opposite side of the base 114.

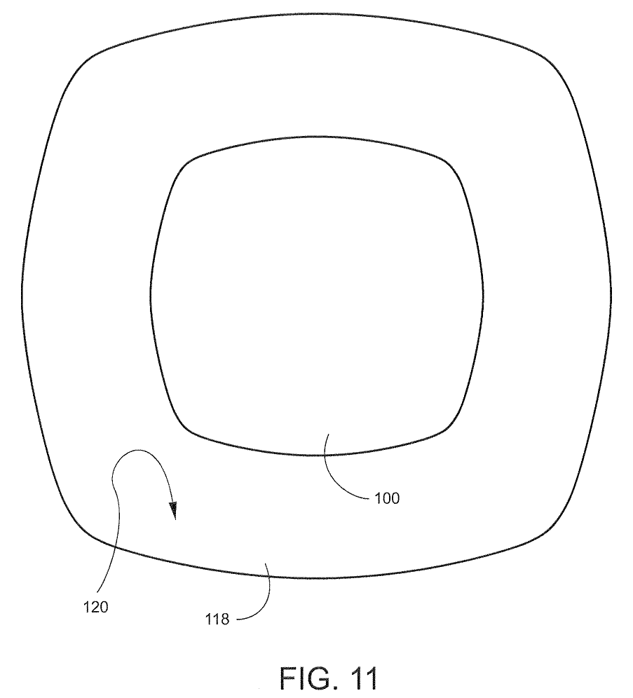

As shown in FIG. 11, a top of a radome 118 (or other cover) may be provided and positioned on top of the base 114 over the aperture board 102 (shown in FIG. 9). A corresponding bottom of the radome 118 (not shown) may be provided on a bottom of the base 114 over the quadrature coupler 104 such that a housing for the antenna 80 is provided. In this embodiment, the dielectric patch element 100 is provided on a top surface 120 of the radome 118 such that the dielectric patch element 100 is placed outside the radome 118 (e.g., incorporated onto the outer skin of the radome 118), thereby spacing the dielectric patch element 100 a distance above the aperture board 102 to define an air gap therebetween. The distance between the dielectric patch element 100 and the aperture board 102 may be varied, for example, by changing the size, shape, outside curvature, etc. of the radome 118. The dielectric patch element 100 may be adhered or connected to the radome 118 using any type of connection means. The dielectric patch element 100 also may be formed from different materials, for example, different types of metals.

It should be noted that the dielectric patch element 100 alternatively may be provided on an inside surface of the top of the radome 118, which still results in the dielectric patch element 100 being spaced a distance from the aperture board 102. The dielectric patch element 100 also may be positioned at some point intermediate between the radome 118 and the aperture board 102, but still a distance from the aperture board 102, for example, with a bracket 106 (shown in FIG. 8).

It also should be noted that although the dielectric patch element 100 is illustrated as a square element, the size and shape can be varied. For example, different shapes or sizes (e.g., different shaped and sized squares and shapes or combinations thereof) of the dielectric patch element 100 may be provided. In general, the dielectric patch element 100 is formed to be symmetric in shape.

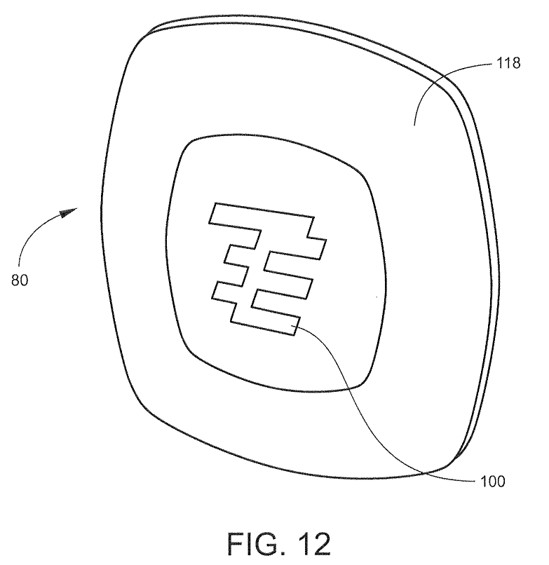

In one embodiment, as shown in FIG. 12, the dielectric patch element 100 may be shaped in a pattern or design, for example, as a logo or other identifier. The metal used to form the dielectric patch element 100 also may be differently grained. It should be noted that the dielectric patch element 100 shown in FIG. 12 maintains symmetry.

Thus, various embodiments of the invention provide an RFID antenna having an aperture coupled patch element having no connection to the aperture board and that provides a broadband response over the entire worldwide UHF RFID frequency range. The dielectric patch element also may be placed on the exterior of the antenna radome such that dielectric losses can be reduced and the height/width of the antenna decreased. The physical layer for the dielectric patch element is thereby eliminated, which includes the eliminating the cost associated therewith.

The various embodiments or components, for example, the RFID reader and components therein or the RFID system communicating with the RFID reader may be implemented as part of one or more computer systems, which may be separate from or integrated with others system. The computer system may include a computer, an input device, a display unit and an interface, for example, for accessing the Internet. The computer may include a microprocessor. The microprocessor may be connected to a communication bus. The computer may also include a memory. The memory may include Random Access Memory (RAM) and Read Only Memory (ROM). The computer system further may include a storage device, which may be a hard disk drive or a removable storage drive such as a floppy disk drive, optical disk drive, and the like. The storage device may also be other similar means for loading computer programs or other instructions into the computer system.

As used herein, the term “computer” may include any processor-based or microprocessor-based system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “Computer”.

The computer system executes a set of instructions that are stored in one or more storage elements, in order to process input data. The storage elements may also store data or other information as desired or needed. The storage element may be in the form of an information source or a physical memory element within the processing machine.

The set of instructions may include various commands that instruct the computer as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A radio frequency identification (RFID) antenna comprising:
an aperture board having at least one opening;
a dielectric patch element spaced a distance from the aperture; and
a quadrature coupler connected to the aperture board and configured to excite the dielectric patch element to generate RFID signals.

2. An RFID antenna in accordance with claim 1 wherein the aperture board comprise two slots.

3. An RFID antenna in accordance with claim 2 wherein the two slots are oriented 90 degrees with respect to each other.

4. An RFID antenna in accordance with claim 1 wherein the aperture board comprise four slots.

5. An RFID antenna in accordance with claim 1 wherein the quadrature coupler is configured to excite the dielectric patch element to generate RFID signals over a frequency range between about 865 MHz and about 956 MHz.

6. An RFID antenna in accordance with claim 5 wherein the quadrature coupler is configured to excite the dielectric patch element to generate RFID signals having an axial ratio of about two decibels or less.

7. An RFID antenna in accordance with claim 5 wherein the quadrature coupler comprises a power divider having an equal power split and a phase difference of ninety degrees.

8. An RFID antenna in accordance with claim 5 wherein the quadrature coupler is configured to excite the dielectric patch element to generate RFID signals circularly polarized over the frequency range between about 865 MHz and about 956 MHz.

9. An RFID antenna in accordance with claim 1 wherein the dielectric patch element comprises symmetrical elements.

10. An RFID antenna in accordance with claim 1 wherein the dielectric patch element comprises an air dielectric patch.

11. An RFID antenna in accordance with claim 1 further comprising a radome and wherein the dielectric patch element is on an outside of the radome.

12. An RFID antenna in accordance with claim 11 further comprising a metal patch element on an outer surface of the radome forming the dielectric patch element.

13. An RFID antenna in accordance with claim 12 wherein the metal patch element is one of embossed and debossed with a logo.

14. An REID antenna in accordance with claim 1 further comprising a bracket spacing the dielectric patch element from the aperture board.

15. A radio frequency (RFID) reader comprising:
a transceiver configured to generate RFID signals over a UHF RFID frequency range from about 865 MHz to about 956 MHz, the generated RFID signals having an axial ratio of no more than about two decibels; and
an antenna connected to the transceiver and having an aperture coupled patch element.

16. An RFID reader in accordance with claim 15 wherein the aperture coupled patch element comprises a dual aperture coupled dielectric patch element.

17. An RFID reader in accordance with claim 15 further comprising an aperture board comprising orthogonal slots and spaced a distance from the aperture coupled patch element.

18. An RFID reader in accordance with claim 15 wherein the antenna comprises a radome and the aperture coupled patch element is on an outside surface of the radome.

19. An REID reader in accordance with claim 15 further comprising an aperture board and wherein the aperture coupled patch element is spaced a predetermined distance from the aperture board.

20. A method of transmitting RFID signals, the method comprising:
generating an RFID signal in a frequency range of about 865 MHz to about 956 MHz; and
transmitting the RFID signal using an aperture coupled patch element.
